(19) United States
(12) Patent Application Publication
(10) Pub. No.: US 2021/0229867 A1
(43) Pub. Date: Jul. 29, 2021

(54) STORAGE CONTAINERS FOR HOIST DEVICES

(71) Applicant: MILWAUKEE ELECTRIC TOOL CORPORATION, Brookfield, WI (US)

(72) Inventors: Karly M. Schober, Milwaukee, WI (US); Jarrod P. Kotes, Grafton, WI (US); Terry L. Timmons, Oconomowoc, WI (US); Kenneth W. Wolf, Muskego, WI (US); Jonathan L. Lambert, Milwaukee, WI (US)

(21) Appl. No.: 17/156,196

(22) Filed: Jan. 22, 2021

Related U.S. Application Data
(60) Provisional application No. 62/965,387, filed on Jan. 24, 2020.

(51) Int. Cl. B65D 25/10; B65D 43/16; B65D 25/28; B65D 43/22

(52) U.S. Cl. CPC B65D 25/108; B65D 43/22; B65D 25/2841; B65D 43/163

(57) ABSTRACT

A storage container for a hoist device includes a base that defines an inner cavity, and a lid pivotally coupled to the base and configured to close the inner cavity. The storage container also includes a lid pivotally coupled to the base and configured to close the inner cavity, a handle pivotally coupled to the base, and a latch configured to selectively secure the lid to the base in a closed state. The base further defines first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device.

### CROSS-REFERENCE TO RELATED APPLICATIONS

This application claims priority to co-pending U.S. Provisional patent Application No. 62/965,387, filed Jan. 24, 2020, the entire content of which is hereby incorporated by reference.

### FIELD OF THE INVENTION

The present invention relates to storage containers for a hoist device.

### BACKGROUND OF THE INVENTION

Hoist devices are used for lifting or lowering work pieces. Such hoist devices may be manually operated, electrically or pneumatically driven and may use chain or chain rope to move work pieces.

Hoist devices generally have unique geometries and require additional accessories for operation. As a result, a need exists for storage containers to allow users to transport or store the hoist devices with its accessories.

### SUMMARY OF THE INVENTION

The present invention provides, in one aspect, a storage container for a hoist device. The storage container includes a base that defines an inner cavity, and a lid pivotally coupled to the base and configured to close the inner cavity. The storage container also includes a lid pivotally coupled to the base and configured to close the inner cavity, a handle pivotally coupled to the base, and a latch configured to selectively secure the lid to the base in a closed state. The base further defines first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device.

The present invention provides, in another aspect, a storage container for a hoist device. The storage container includes a base that defines an opening and an inner cavity, a handle pivotally coupled to the base, and a lid releasably coupled to the base and configured to selectively close the opening. The storage container further includes a latch configured to selectively secure the lid to the base, and a tray configured to be received within the opening. The tray defines a first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device.

The present invention provides, in another aspect, a storage container unit for a hoist device. The storage container unit includes a first storage container and a second storage container. The first storage container includes a first base that defines a first opening and a first inner cavity. The first storage container also includes a first lid releasably secured to the first base and configured to selectively close the first opening, a retractable handle coupled to the first base, and an insert received within the first opening and defining a receptacle. The second storage container includes a second base that defines a second opening and a second inner cavity, and a second lid releasably secured to the second base and configured to selectively close the second opening. The first lid defines a recess configured to receive a bottom portion of the second base, the recess having a shape corresponding to the bottom portion.

### BRIEF DESCRIPTION OF THE DRAWINGS

FIG. 1 illustrates a hoist device.

FIG. 2 is an exploded view of a storage container for a hoist device in accordance with an embodiment of the invention.

FIG. 3 is a top view of the storage container of FIG. 2.

FIG. 4 is a perspective view of an insert for use with the storage container of FIG. 2.

FIG. 5A is a side view of a storage container for a hoist device in accordance with another embodiment of the invention.

FIG. 5B is a perspective view of a storage container for a hoist device in accordance with yet another embodiment of the invention.

FIG. 5C is a side view of a storage container for a hoist device in accordance with a further embodiment of the invention.

FIG. 6 is a perspective view of a blow molded inner cavity of the storage container of FIG. 5A.

FIG. 7 is a perspective view of a storage container for a hoist device in accordance with another embodiment of the invention.

FIG. 8 is a perspective view of the storage container of FIG. 7, with portions removed.

FIG. 9 is a perspective view of a storage container for a hoist device in accordance with yet another embodiment of the invention.

FIG. 10 is a perspective view of the storage container of FIG. 9.

FIG. 11 is an exploded perspective view of a storage container unit for a hoist device in accordance with a further embodiment of the invention.

FIG. 12 is a perspective view of an inner cavity of one of the storage containers of the unit of FIG. 11.

FIG. 13 is a perspective view of one of the storage containers of the unit of FIG. 11.

### DETAILED DESCRIPTION

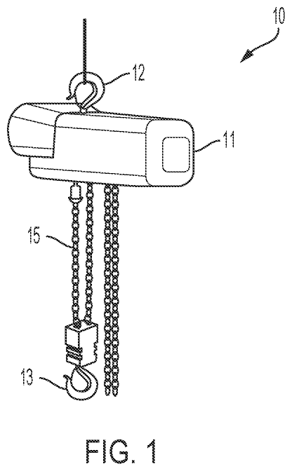

FIG. 1 illustrates one example embodiment of a hoist device 10 that may be positioned within the storage containers of the present disclosure. The hoist device 10 includes a main body 11 containing a motorized lifting mechanism, a first hook 12 coupled to the main body 11, a second hook 13, and a chain 15 connecting the second hook 15 to the lifting mechanism of the main body 11. The hoist device 10 can be a component of a wireless hoist system as described and illustrated in co-pending, co-owned U.S. Patent Application No. 62/951,394 filed Dec. 20, 2019, which is incorporated herein by reference in its entirety.

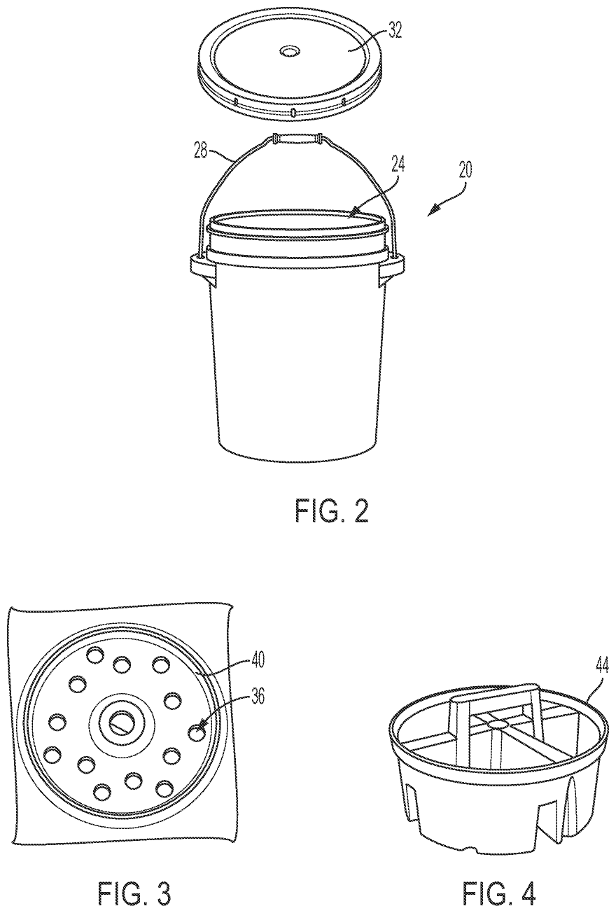

FIG. 2 illustrates a cylindrical storage container 20 having an opening 24 to receive the hoist device 10, a carrying handle 28, and a lid 32 to enclose the opening 24 to define a storage area. The lid 32 may include a recess having a shape corresponding to the bottom of the container 20 to facilitate stacking multiple containers 20. The storage container 20 may vary in size depending on the size of the hoist device 10. For example, the storage container 20 may be approximately the size of a five gallon bucket. In other embodiments, the storage container 20 may be larger than a five gallon bucket.

The carrying handle 28 may be pivotally coupled to the storage container 20 so the handle 28 is positioned above the opening 24. In other embodiments, the storage container 20 may include a pair of handles coupled to the sides of the storage container 20. In some embodiments, the storage container 20 may be opaque or clear color to allow the user to identify which tool is in the container 20.

With reference to FIG. 3, the storage container 20 may include drainage apertures 36 positioned in a bottom wall 40 of the storage container 20. The drainage apertures 36 allow water to drain out from the interior of the storage container 20, preventing the accumulation of water, or other liquid or debris, within the storage container 20.

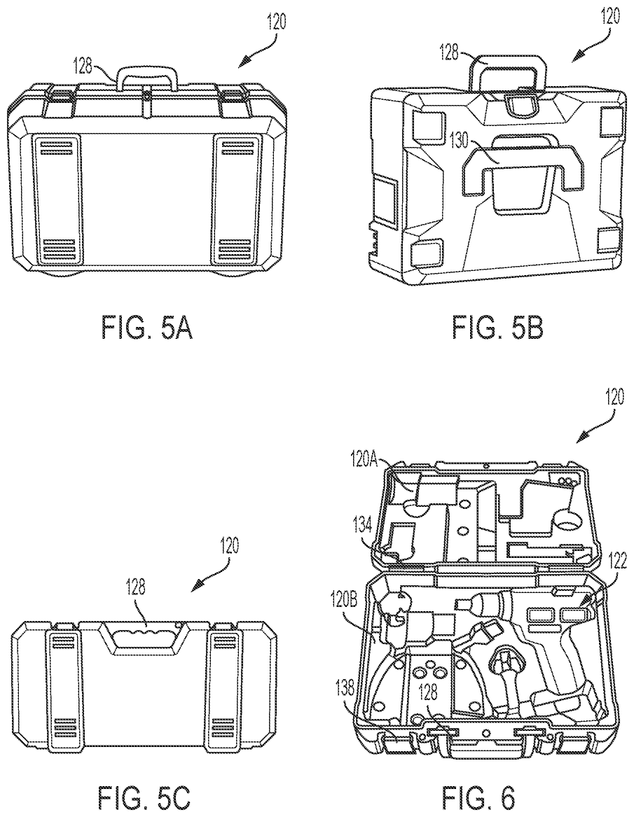

With reference to FIG. 4, the storage container 20 may include one or more inserts or trays 44 that are received within the opening 24 of the storage container 20. The tray 44 may include one or more storage receptacles sized and/or shaped for specific components or accessories of the hoist device 10. Specifically, the tray 44 may include a first storage receptacle sized and/or shaped to receive the main body 11 of the hoist device 10, a second storage receptacle sized and/or shaped to receive the first hook 12, a third storage receptacle sized and/or shaped to receive the second hook 13, and/or a fourth storage receptacle sized and/or shaped to receive the chain 15. Each of the storage receptacles may be vertically aligned, such that all of the storage receptacles are intersected by a vertical plane when the storage container 20 is held aloft by the handle 28. It should be appreciated that any of the features illustrated in FIGS. 1-4 may be incorporated with the storage containers described below with reference to FIGS. 5A-13.

With reference to FIGS. 5A-6, a storage container 120 according to another embodiment is illustrated. The storage container 120 may include an inner cavity 122 (FIG. 6) that is blow molded to provide one or more storage receptacles sized and/or shaped for the hoist device 10 and its associated components and accessories. Specifically, the storage container 120 may define, within the inner cavity 122, a first storage receptacle sized and/or shaped to receive the main body 11 of the hoist device 10, a second storage receptacle sized and/or shaped to receive the first hook 12, a third storage receptacle sized and/or shaped to receive the second hook 13, and/or a fourth storage receptacle sized and/or shaped to receive the chain 15. In some embodiments, the storage container 120 may include a carrying handle 128 pivotally coupled to a top portion of the storage container 120 (FIG. 5A). In other embodiments, the storage container 120 may include an additional carrying handle 130 coupled to a side portion of the storage container 120 (FIG. 5B). In yet another embodiment, the storage container 120 may include the carrying handle 128 integrally formed on the storage container 120.

The storage container 120 may include a first container part or lid 120A and a second container part or base 120B pivotally coupled to the lid 120A via a hinge 134. The storage container 120 may further include a latch 138 to secure the lid 120A and base 120B in a closed state. The exterior of the lid 120A and the base 120B may be flat or incorporate a feature that allows multiple storage containers 120 to be interlockingly stacked. In some embodiments, the storage container 120 may include drainage apertures, similar to the drainage apertures 36, to prevent the accumulation of water, or other liquid or debris, within the storage container 120.

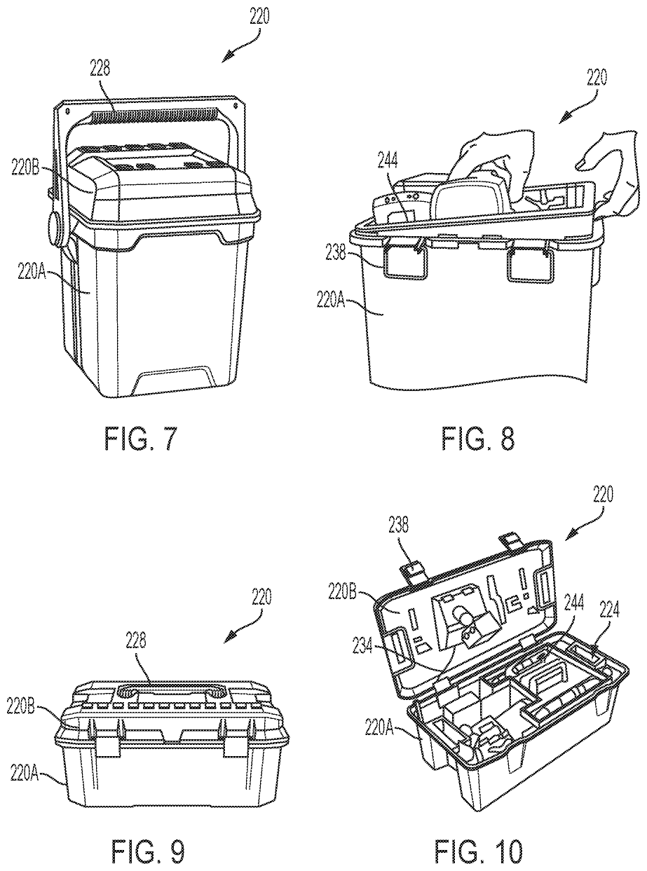

With reference to FIGS. 7-10, a storage container 220 according to another embodiment is illustrated. The storage container 220 includes a first container part or base 220A and a second container part or a lid 220B. In some embodiments, the lid 220B may be removably coupled to the base 220A and secured via a latch 238 (FIG. 8). In other embodiments, the lid 220B may be pivotally coupled to the base 220A via a hinge 234 (FIG. 10). The storage container 220 may include a handle 228 coupled to the base 220A (FIG. 7) or a handle 228 to the lid 220B (FIG. 9).

The storage container 220 may include one or more inserts or trays 244 that are received within an opening 224 of the storage container 220. The tray 244 may include storage receptacles shaped and/or sized to receive specific components or accessories of the hoist device 10. Specifically, the tray 144 may include a first storage receptacle sized and/or shaped to receive the main body 11 of the hoist device 10, a second storage receptacle sized and/or shaped to receive the first hook 12, a third storage receptacle sized and/or shaped to receive the second hook 13, and/or a fourth storage receptacle sized and/or shaped to receive the chain 15.

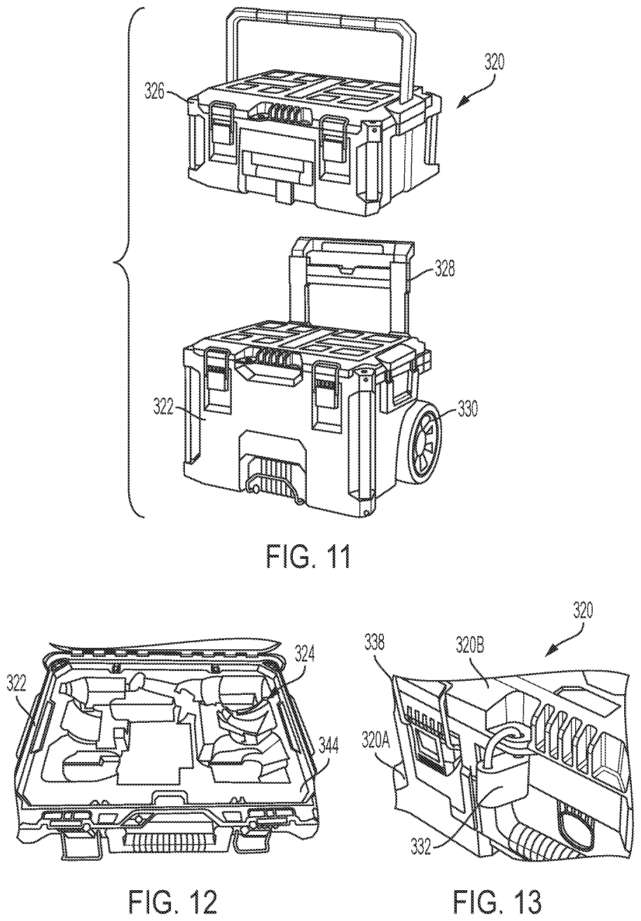

With reference to FIGS. 11-13, a storage container unit 320 according to another embodiment is illustrated. The storage container unit 320 includes a base storage container 322 and a stackable storage container 326. The base storage container 322 may include a retractable handle 328 and wheels 330 to allow the storage container unit 320 to be easily maneuvered. The stackable storage container 326 is secured on a top portion or lid of the base storage container 322 using interlocking features on the storage containers 322, 326, permitting the containers 322, 326 to be transported as a single unit 320 without concern that the containers 322, 326 unintentionally separate.

Each of the storage containers 322, 326 may include any combination of dividers, trays, custom plastic molded inserts and foam organizer inserts. For example, FIG. 12 illustrates a foam insert 344 positioned within an opening 324 of the storage containers 322, 326 defining one or more storage receptacles shaped and/or sized to receive specific components or accessories of the hoist device 10. Specifically, the foam insert 344 may include a first storage receptacle sized and/or shaped to receive the main body 11 of the hoist device 10, a second storage receptacle sized and/or shaped to receive the first hook 12, a third storage receptacle sized and/or shaped to receive the second hook 13, and/or a fourth storage receptacle sized and/or shaped to receive the chain 15.

With reference to FIG. 13, the storage containers 322, 326 may further include a latch 338 to secure a lid 320B to a base 320A of the storage containers 322, 326. The storage containers 322, 326 may include a lock 332 that prevents access to the interior of the storage containers 322, 326 even if the latches 338 are released.

Various features of the disclosure are set forth in the following claims.

What is claimed is:

1. A storage container for a hoist device, the storage container comprising:
a base that defines an inner cavity, a first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device;
a lid pivotally coupled to the base and configured to close the inner cavity;
a handle pivotally coupled to the base; and
a latch configured to selectively secure the lid to the base in a closed state.

2. The storage container of claim 1, wherein the handle is a first handle, and wherein the first handle is pivotally coupled to a top portion of the base, and wherein the storage container further includes a second handle pivotally coupled to a side portion of the base.

3. The storage container of claim 1, wherein the base includes a plurality of drainage apertures configured to prevent accumulation of water within the inner cavity.

4. The storage container of claim 1, wherein each of the first storage receptacle, the second storage receptacle, the third storage receptacle, and the fourth storage receptacle is intersected by a vertical plane when the storage container is held aloft by the handle.

5. The storage container of claim 1, wherein the base includes a first interlocking feature and the lid includes a second interlocking feature, and wherein the first interlocking feature and the second interlocking feature have complementary shapes.

6. The storage container of claim 1, further including a tray configured to be received within the inner cavity, the tray defining a fifth storage receptacle having a shape corresponding to at least one of the main housing, the first hook, the second hook, and the chain.

7. A storage container for a hoist device, the storage container comprising:
a base that defines an opening and an inner cavity;
a handle pivotally coupled to the base;
a lid releasably coupled to the base and configured to selectively close the opening;
a latch configured to selectively secure the lid to the base;
a tray configured to be received within the opening, the tray defining a first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device.

8. The storage container of claim 7, wherein the handle is a first handle, and wherein the first handle is pivotally coupled to a top portion of the base, and wherein the storage container further includes a second handle pivotally coupled to a side portion of the base.

9. The storage container of claim 7, wherein the latch is a first latch and the storage container further comprises a second latch configured to selectively secure the lid to the base.

10. The storage container of claim 7, wherein the base includes a plurality of drainage apertures configured to prevent accumulation of water within the inner cavity.

11. The storage container of claim 7, wherein each of the first storage receptacle, the second storage receptacle, the third storage receptacle, and the fourth storage receptacle is intersected by a vertical plane when the storage container is held aloft by the handle.

12. The storage container of claim 7, wherein the base includes a first interlocking feature and the lid includes a second interlocking feature, and wherein the first interlocking feature and the second interlocking feature have complementary shapes.

13. A storage container unit for a hoist device, the storage container unit comprising:
a first storage container including
a first base that defines a first opening and a first inner cavity;
a first lid releasably secured to the first base and configured to selectively close the first opening,
a retractable handle coupled to the first base, and
an insert received within the first opening and defining a receptacle;
a second storage container including
a second base that defines a second opening and a second inner cavity,
a second lid releasably secured to the second base and configured to selectively close the second opening;
wherein the first lid defines a recess configured to receive a bottom portion of the second base, the recess having a shape corresponding to the bottom portion.

14. The storage container unit of claim 13, wherein the first storage container further includes a plurality of wheels coupled to the first base.

15. The storage container unit of claim 13, wherein the first storage container further includes a latch configured to selectively secure the first lid to the first base.

16. The storage container unit of claim 15, wherein the latch is a first latch and the first storage container further comprises a second latch configured to selectively secure the first lid to the first base.

17. The storage container unit of claim 13, wherein each of the first base and the second base further defines a first storage receptacle having a first shape corresponding to a main body of the hoist device, a second storage receptacle having a second shape corresponding to a first hook of the hoist device, a third storage receptacle having a third shape corresponding to a second hook of the hoist device, and a fourth storage receptacle having a fourth shape corresponding to a chain of the hoist device.

18. The storage container unit of claim 13, wherein the first lid further includes at least one interlocking feature to releasably secure the second base to the first lid.

19. The storage container unit of claim 13, further including a lock configured to selectively prevent access to at least one of the first inner cavity and the second inner cavity.

20. The storage container unit of claim 13, wherein the first base includes a plurality of drainage apertures configured to prevent accumulation of water within the first inner cavity.
